(19) United States
(12) Patent Application Publication
(10) Pub. No.: US 2017/0118735 A1
(43) Pub. Date: Apr. 27, 2017

(54) Verification of Time Signals

(71) Applicants: Christoph Ruland, Siegen (DE); Matthias Schneider, Wilnsdorf (DE)

(72) Inventors: Christoph Ruland, Siegen (DE); Matthias Schneider, Wilnsdorf (DE)

(21) Appl. No.: 14/924,024

(22) Filed: Oct. 27, 2015

(51) Int. Cl. H04W 56/00; H04L 27/14

(52) U.S. Cl. CPC H04W 56/0055; H04L 27/14

(57) ABSTRACT

A method is proposed for verification of time data from a time signal modulated on a continuous carrier signal with steps to receive a first time signal with a first reference time, to receive a second time signal with a second reference time, which follows the first reference time in time, for calculation of the target time interval lying between the reference times from the time data contained in the received time signal, to determine a time interval and determine a reference time interval, using counting of periods of the continuous carrier signal within the time interval, for comparison of the target time interval with the reference time interval and to send an error signal, if the deviation determined by the comparison surpasses a stipulated tolerance value.

### FIELD

The present disclosure is generally related to concerns line or wireless transmission of time signals and especially a method for verification of time data from time signals modulated onto a continuous carrier signal and a device for execution of this method.

### BACKGROUND

Automatic adjustment of freely running clocks by line-transmitted or wireless time information is well known from the prior art. Time information, which is modulated onto a continuous carrier signal with definable allocation of the reference point, is referred to subsequently as a time signal.

A known example of such a time signal are the time signals that have already been broadcast for several decades via long-wave transmitters, which fill up a stipulated time grid with variable and typically amplitude-modulated symbols. The time reference of the transmitted time information is given by the time grid. Details concerning this are provided in the article “Time and Frequency Distribution with the DCF77” in the March 2009 issue of PTB Mitteilungen, which can be retrieved online via [http ://www.ptb . de/cms/fileadmin/internet/publikationen/mitteilungen/2009/PTB Mitteilungen_2009_Heft_3.pdf]. A method is also known for recovery of time information from such a time signal in the document DE 10 2004 005 340 A1.

Another known example for time signals are the time telegrams transmitted in packet-oriented fashion, which are used, among other things, for synchronization of receivers in ripple control technology during operation of electrical grids. Ripple control technology permits network operators to control consumers and/or supply systems. For example, the network operator can selectively influence decentralized supply systems in Germany by ripple control technology according to the Law for Priority of Renewable Energies (EEG), for example, solar systems, wind and hydroelectric power systems, by ripple control telegrams for purposes of load curve control. Ripple control telegrams can be line-transmitted via the power grid and wirelessly via radio. Wirelessly transmitted ripple control telegrams are referred to as radio ripple control telegrams. Europäische Funk-Rundsteuerung GmbH [European Radio Ripple Control] makes such a wireless transmission channel available via a long-wave transmitter. Time telegrams for time synchronization of receivers are also broadcast via this transmitter, in addition to the radio ripple control telegrams. Document DE 102 14 146 C1 is referred to for additional details, which discloses a radio ripple control system for controlling a number of decentralized customer terminal devices as a function of customer-initiated transmission desires by means of central long-wave transmitters.

### SUMMARY

However, the problem that unrecognized distortion is possible on wireless transmission links remains with the known methods for extracting time information from time signals. For example, so-called replay attacks appear to be promising relative to the known methods, in which already broadcast time telegrams are received and broadcast again in the vicinity of the receiver being attacked with comparatively higher local field strength.

A solution in this respect is offered by the present method for verification of time data from a time signal modulated on a continuous carrier signal with the features stated in claim 1 and a device for providing a remotely synchronized verified time base with the features stated in claim 8. Advantageous embodiments and modifications are stated in the dependent claims.

As a basis, a method is proposed for verification of time data from a time signal modulated on a continuous carrier signal with steps for receiving a first time signal with a first reference time, for receiving a second time signal with a second reference time, which follows the first reference time, for calculation of the target time interval lying between the reference times from the time data contained in the received time signal, for determination of a time interval and determination of the reference time interval, using counting of periods of the continuous carrier signal within the time interval, for comparison of the target time interval with the reference time interval and to produce an error signal if the deviation determined by the comparison exceeds a stipulated tolerance value.

One advantage of this method can be seen in the fact that verification of the received time data is possible from the received signal and no additional time base is required. It also appears advantageous that verification by reference to the continuous carrier signal is independent of fluctuations in speed of transmission of the continuous carrier signal between the transmitter and receiver. For example, a phase fluctuation caused by atmospheric fluctuations or movement of the receiver remains unconsidered.

In a first alternative of an embodiment of the basic method, the periods of the continuous carrier signal are counted in the time interval between the reference times of the received time signals for verification of the time data from time signals transmitted in a fixed time grid for determination of the reference time interval.

In a second alternative of an embodiment of the basic method, the periods of the continuous carrier signal are counted in the time interval between the received time telegrams and the reference time interval obtained by addition of a packet time to verify the time data from time telegrams transmitted in packet-oriented fashion in a loose time grid for determination of the reference time interval.

In one embodiment of the previous two alternatives, the packet time is also determined by counting the periods of the continuous carrier signal during transmission of a time telegram.

In an independent embodiment of the preceding two alternatives, during counting of the periods of a frequency-modulated continuous carrier signal, the counted periods are weighted with the period time, which varies by frequency modulation.

In one embodiment of the previous method, the variation of period time of the frequency-modulated continuous carrier signal is established according to data derived by demodulation.

An advantage of this embodiment can be seen in the fact that no additional expense is incurred for direct measurement of the period time or direct detection of modulation. The time trend of the modulation and therefore the period time is instead constructed from the data of the decoded time or data telegrams, which are already available anyway.

In one embodiment of the previous method, during determination of the packet time the variation of period time of the frequency-modulated continuous carrier signal is established based on frequency modulation according to a time telegram corresponding to the first reference time. If the received signal is undistorted, the variation of period time determined with it agrees with the actually received signal and the packet time determined with it is correct.

An advantage of this embodiment can be seen in the fact that verification itself is still possible if the transmission quality still permits the period of the continuous carrier signal to be recognized but perfect demodulation is no longer possible.

In one embodiment of the previous method, a stipulated value is added as packet time.

A device is also proposed for providing a remotely synchronized verified time base, having receivers to receive a continuous carrier signal with modulated time signal, decoding devices to extract the time signal from the continuous carrier signal and for marking of a time interval by start and end mark signals, calculation devices to calculate the target time interval lying between the reference times from the time data contained in the received time signal, counting devices to count the periods of the continuous carrier signal in the time interval between the start and end mark signals, conversion devices to convert the counted periods into a reference time interval and comparison devices to compare the target time interval with the reference time interval and to send an error signal to an error control unit, if the deviation determined by the comparison exceeds a stipulated tolerance value. The error signal can also be produced, if the time signal could not be used, for example, during a transmission disturbance.

In one embodiment of the basic device, the receiving devices are designed as direct receivers and include in particular a selective amplifier.

In one embodiment of the basic device, the decoding devices include a demodulator for demodulation of a frequency-modulated signal and a frame synchronization unit for frame synchronization of transmitted data packets.

In another embodiment, a previously defined device is designed as a billing unit in a charging station, a taximeter, a wind power system, a solar system or as another unit in which time-dependent actions are conducted, in which case correctness of the available time base must be present.

In another embodiment, a previously defined device is designed as a time service calculator, time server, trusted platform module (TPM) or hardware security module (HSM).

The term “continuous carrier signal” subsequently denotes an electromagnetic carrier signal supplied continuously to the transmission channel. The transmission channel can be a physical medium or a free radio link. An electrical conductor, a wave guide or light guide can serve as physical medium. If broadcast of a radio carrier signal is referred to, a free radio link is subsequently assumed. Continuous supply of the carrier signal presumes appropriate choice and establishment of the modulation required in principle for data transmission. If frequency- and/or phase modulation methods are used, no additional restrictions arise. When an amplitude modulation method is used, the modulation index must be established so that the radio carrier signal can still be detected with sufficient reliability on the transmission channel, even during limited amplitude at the location of the prescribed receiver.

The term “time mark” denotes time information transmitted by modulation of a continuous carrier signal. A time mark can be a time signal or time telegram.

The term “time signal” denotes a data structure transmitted continuously in a fixed time grid with time information contained therein. Typically the fixed time grid is uniform and the data structure is transmitted periodically as repeating. The fixed time grid permits particularly precise determination of the so-called “reference time” of the time information within the time signal. The reference time in a time signal is the time within the transmission at which the time designated with the time signal is reached. A known time signal is the wirelessly transmitted DCF77, which is broadcast by the Mainflingen transmitter via an amplitude-modulated continuous carrier signal with a frequency of 77.5 kHz and a fixed time grid of one second. One symbol is transmitted each second. The reference points of this time signal then lie at the end of a 60-second frame. As a peculiarity, the DCF77, in addition to the amplitude-modulated data unit with the time information, has pseudorandom phase shift keying (PSK) repeating with the fixed time grid. This permits very precise determination of the reference points at the end of 60 second frame by cross-correlation of the received signal relative to a signal of the same frequency generated in the receiver with identical pseudorandom phase shift keying. The article in PTB Mitteilungen mentioned in the introduction is referred to for additional details.

The term “time telegram” denotes a transmitted data packet with the time information contained therein. The structure of the data packet then corresponds to a determined or determinable scheme so that the contained time information can be allocated to a specified reference time within or in the vicinity of the broadcast time of the time telegram. For example, the reference time can correspond to the time of transmission of the first symbol in the data packet. In contrast to the previously defined time signal, transmission of the time telegram need not occur in a stipulated time grid. Time telegrams can be transmitted in a loose time grid which does not permit or only to a limited extent permits prediction of the possibility of reception on the receiver side. Consequently, in practical applications, the continuous carrier signal used for transmission of time telegrams is simultaneously used to transmit other telegrams. Depending on the occurrence and prioritization of these other telegrams, transmission of the time telegrams can be suppressed in the sense that the time interval between consecutive time telegrams is increased. Accordingly, the possibilities for predictable reception of time data are reduced for a receiver of the time telegrams.

Operation of a technical infrastructure for transmission of time signals is referred to as “time service”. Such a technical infrastructure typically includes a time normal, which produces the binding basis for the time signals being broadcast. The time normal is typically furnished by an atomic clock. The technical infrastructure also includes a high frequency transmitter to broadcast a modulated continuous carrier signal, from which the time signals with the time data could be derived by an appropriate demodulation method. Long-wave transmitters with a working frequency of 30 to 300 kHz appear to be particularly suited for this purpose because the electromagnetic waves broadcast with them cover very large distances with very small travel times. In addition, broadcast of time signals requires only very little bandwidth.

### BRIEF DESCRIPTION OF THE DRAWINGS

Exemplary methods for verification of time data from a time signal modulated on a continuous carrier signal and an example of a device for execution of such a method are shown in the appended drawings. In them:

FIG. 1 shows a schematic signal path of an amplitude-modulated continuous carrier signal with a fixed time grid as basis for a first method;

FIG. 2 shows a depiction of the time sequence of data packets in a packet-oriented transmission scheme as a basis for a second exemplary method; and

FIG. 3 shows an exemplary device for performance of the second exemplary method for the transmission scheme according to FIG. 2. In the following discussion, the same reference numbers are used in the various embodiments to indicate the same or similar elements.

### DETAILED DESCRIPTION OF ILLUSTRATIVE EMBODIMENTS

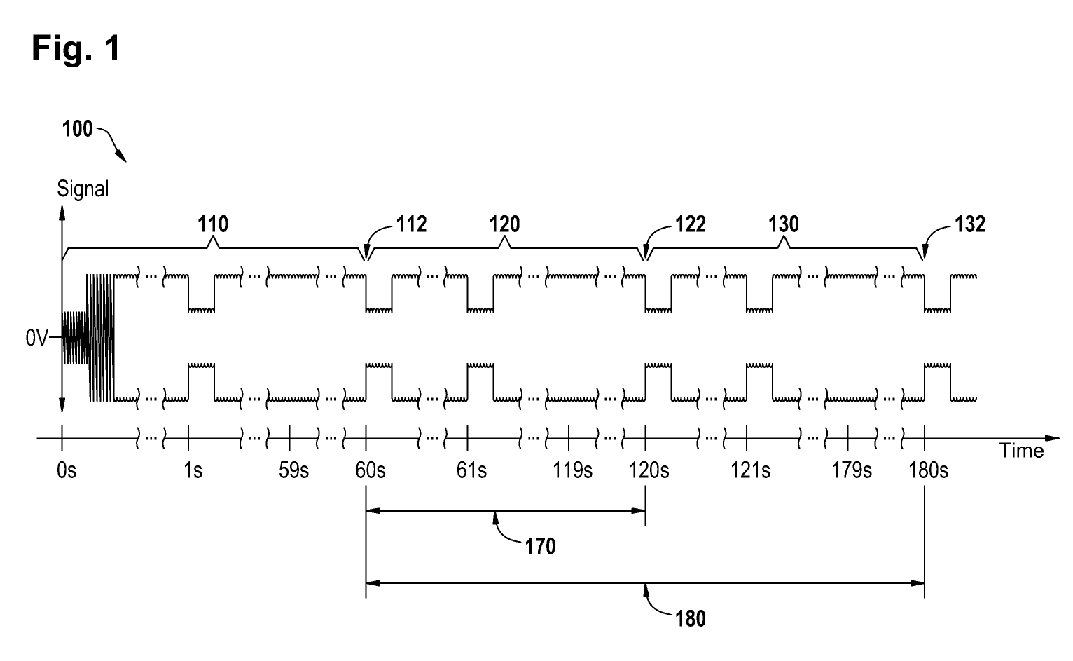

The schematic depiction in FIG. 1 shows a typical time signal path 100 for transmission of time signals 110, 120, 130 on a transmitter and receiver. The received signal is present during undisturbed reception uninterrupted in time because the transmission uses a continuous carrier signal. Several immediately consecutive time signals 110, 120, 130 are coded by amplitude modulation on the continuous carrier signal. The time signals 110, 120, 130 lie in a stipulated time grid and each contains time information. In addition, the time signals mark the reference time 112, 122, 132 pertaining to the time information.

In the exemplary situation the time information and references times 112, 122, 132 are coded on the continuous carrier signal by three different symbols, which are sent in a time second grid. The logic values 0 and 1 are represented by a short or long reduction of signal amplitude at the beginning of the corresponding second. The symbol for the reference time is produced by omitting the reduction. The subsequent falling flank in signal intensity can therefore be used to recognize the reference time. Transmission is repeated in a 60-second frame. Accordingly, symbols with binary data, in which the time information belonging to the reference time is appropriately coded, precede the symbol for display of the reference time 59 in each time signal 110, 120, 130.

The measures and devices for reception of the time signals 110, 120, 130, for extraction of the time information and for recognition of the reference times 112, 122, 132 are known and are therefore not further presented here. During reception of a time signal 110, 120, 130, time information is decoded and this can be used relative to the subsequently recognized reference time 112, 122, 132 for synchronization of a local clock of the receiver or for any other purpose.

In particular, if the carrier frequency of the continuous carrier signal is stabilized with the same time base, from which the time information transmitted with time signals 110, 120, 130 is derived, this permits simple verification or consistency checking of subsequently received time signals 110, 120, 130 through the first exemplary method explained below.

In the first exemplary method, for verification after reception of a first time signal 110 and specifically in the present case on recognition of the reference time 112 for decoded time information, counting of the periods of the continuous carrier signal is started, which is stopped with reception of a second subsequent time signal 120 or 130 at this reference time 122 or 132. The second time signal 130 need not directly follow the first time signal 110. A longer period with a number of additional time signals 120 can also extend between reception of the first and second time signal 110, 130, as long as uninterrupted reception of the continuous carrier signal is guaranteed in each case for counting of the periods.

After completion of counting, a target time interval is calculated from the time data of the first and second received time signals 110, 120 or 110, 130. A time interval 170, 180 is calculated from the counted periods of the continuous carrier signal via the known carrier frequency, which is referred to here as reference time interval owing to referral to the continuous carrier signal of the time reference. If the deviations determined by comparison between the target time interval and reference time interval surpass a stipulated tolerance value, an error signal is produced.

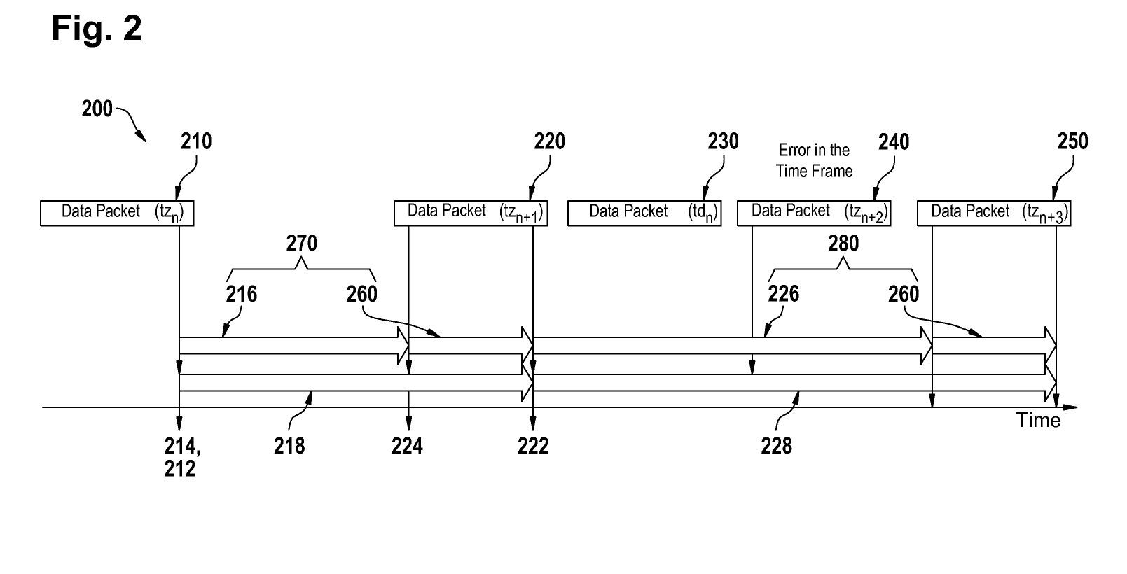

An exemplary packet-oriented data transmission scheme 200 is shown in FIG. 2. This data transmission scheme is produced, for example, in the known ripple control and especially in radio ripple control for power supply grids. Since this transmission scheme largely corresponds to the well known approaches for packet-oriented transmission schemes, the subsequent presentation will be restricted to the second exemplary method for verification explained below in its essential aspects.

In the course of time, from left to right, several data packets 210, 220, 230, 240, 250 are transmitted. In particular, these data packets are four time telegrams 210, 220, 240, 250 and a data telegram 230. The times of corresponding transmission are not rigidly established but are determined on the transmitter side. However, the data packets 210, 220, 230, 240, 250 are delimited in time relative to each other during transmission by packets and in particular may not overlap in time. The modulation also maintains a stipulated time grid within the data packets 210, 220, 230, 240, 250. From it the time position of a received data packet in the received signal can be established by a measure referred to as frame synchronization. At least one small time interval that is not used for transmission is typically found between data packets 210, 220, 230, 240, 250, and therefore contains the continuous carrier signal without any modulation pattern.

Based on a signal with the time transmission scheme according to FIG. 2, the second exemplary method for verification of time data from time telegrams is obtained with the following measures.

For this purpose a first time telegram 210 is initially received for a first reference time 212. In particular, a data stream is generated by demodulation of the received continuous carrier signal, from which the corresponding first time information is recovered by decoding. The reference point 212 for the first time telegram 210 is also obtained by frame synchronization of the received time telegram 210.

Coherent with frame synchronization of the first time telegram 210 a start mark signal 214 is generated, which coincides with the reference time 212 of the first time telegram. The start mark signal 214 designates the beginning of a time interval 216, during which periods of the continuous carrier signal are detected and counted. This counting is ended by an end mark signal 224, which is derived from frame synchronization of the second time telegram 220 and coincides with the beginning of the second time telegram 220. Moreover, the second time telegram 220 is received in the same manner and processed like the first one. The time information contained in it is extracted in particular.

The target time interval 218 lying between the reference times 212 and 222 is also determined from the time data of the first and second time telegrams 210, 220. This target time interval 218 corresponds to the time elapsed on the transmitter side for transmission between reference times 212, 222 in the measurement according to the time normal used by the transmitter.

In addition, a reference time interval 270 is determined via the periods of the continuous carrier signal counted during the time interval 216 between the start mark signal 214 and the end mark signal 224. The packet time 260, i.e., the time length of the second time telegram 220, forms a first contribution to the reference time interval 270.

This packet time 260 is presumed to be present as a uniform and stipulated value for all time telegrams. The further contribution 216 to reference time interval 270 based on time interval 216 is derived from the periods counted between the start mark signal 214 and the end mark signal 224. Derivations can occur based only on the counted value, if the frequency of the continuous carrier signal during counting is unchanged or the fluctuations of period time present from possibly present frequency modulation is compensated in the sum via the time interval 216.

In the exemplary data transmission according to FIG. 2, the presence of this condition in the sense of a first alternative can be assumed in the gap between the first 210 and the second time telegram 220.

If, on the other hand, in the sense of a second alternative the period time of the continuous carrier signal undergoes a change due to frequency modulation during counting, as is the case, for example, at the location of data telegram 230, this change should be appropriately considered to improve the accuracy in determining the reference time interval 280. In principle, several approaches are considered for this purpose.

Initially, the modulation state of the continuous carrier signal could be continuously detected directly. However, this detection is beset with indistinctness because the time limits of the individual symbols of modulation can no longer be precisely established by processing other received signals. In addition, the determinability of these time limits can be compromised by disturbances on the transmission link.

These problems can be at least partially eliminated by a modified approach. For this purpose, the data stream read from the continuous carrier signal by demodulation and decoding is used as a basis for a model of the transmitted continuous carrier signal. The received signals are therefore reconstructed in the stipulated exact time grid. If the symbols are correctly demodulated and decoded, the ideal frequency response at the transmitter is obtained by this reconstruction. In addition, measures of error correction on the data coded with the symbols can further contribute to finding this ideal frequency response. With this approach the content of the data telegram 230 is read and the frequency response ideally sent for its transmission reconstructed based on the stipulated data and symbol layout.

The more extensive approach could prescribe determination of the frequency response and modulation pattern independently of the actually received continuous carrier signal. However, this is only possible if the data sent on the transmission link are fixed beforehand to the extent that the contents of the following data packet can be determined starting from a correctly recognized data packet. This would be the case, in particular, if the continuous carrier signal is used exclusively for transmission of the time telegrams and these time telegrams are exclusively transmitted at the stipulated reference times. A conclusion concerning the content could then be made from the time of reception of the data packet. However, this would not be the case in most practically relevant application scenarios.

In one possible embodiment of the exemplary method, it could be prescribed to also determine the packet time 260 by one of the previously explained approaches. A method modified in this way could get by with data packet of alternating length.

Finally, in the second exemplary method, the target time interval 218 is compared with the reference time interval 270. For this purpose, the difference is formed from the two values. If this difference exceeds a stipulated tolerance value, an error signal can be produced.

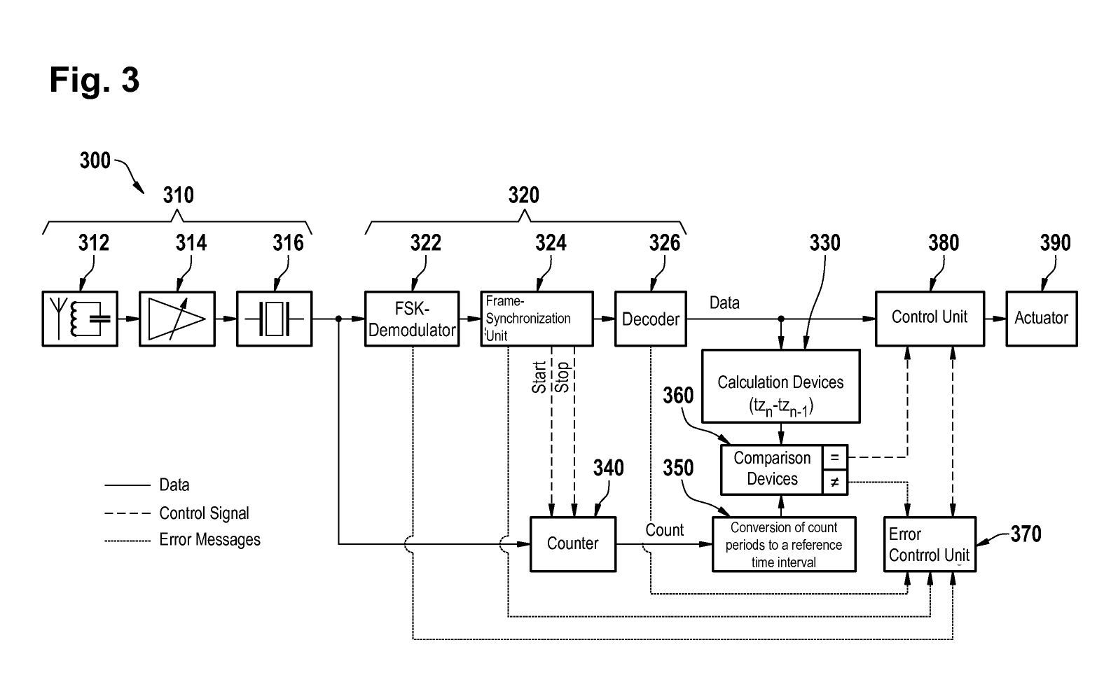

The second exemplary method for verification of time information from time telegrams presented above can be conducted with the exemplary device 300 for furnishing a remote synchronized verified time base according to FIG. 3. This comprises the assemblies or functional units explained below along the processing path, i.e., in the direction of signal and data flow.

At the beginning of the processing path, receiving devices 310 are provided to receive the continuous carrier signal with the frequency-modulated data structures. In particular, the receiving devices 310 include an antenna loop 312 adapted to the frequency of the continuous carrier signal, which is connected to the input of a direct receiver 314. The direct receiver 314 is preferably a frequency-selective amplifier, which can provide particularly good suppression of interference signals and noise.

A direct receiver 314, relative to the superheterodyne receivers typically used in comparable situations, has the advantage here that it does not suppress or weaken the continuous carrier signal. The continuous carrier signal can consequently be used by counting the elapsing periods as a time base. The amplified continuous carrier signal available at the output of the direct amplifier 314 is also expediently fed via filter 316 to subsequent processing.

The processing path also contains decoding devices 320 to extract data from the continuous carrier signal and establish the timeframe of data transmission. In particular, the decoding devices 320 in the exemplary situation contain a demodulator 322 in order to extract the transmitted data packet (namely the time and data telegrams) by demodulation of the continuous carrier signal and make them available for subsequent processing to additional devices. The decoding devices 320 in the exemplary situation also contain a frame synchronization unit 324 to determine the frame, i.e., the time position of the transmitted data packets.

The frame synchronization unit 324 in the exemplary embodiment is also set up to produce the start and end mark signals for indication of a time interval. These start and end mark signals are derived in particular from stipulated reference points in the frame of the packet transmission. In particular, the frame synchronization unit 324 in the exemplary embodiment is set up to generate the start mark signal at the end of a previous time telegram and the end mark signal at the beginning of one of the subsequent time telegrams.

The processing path also contains calculation devices 330 to calculate the target time interval 218, 228 between the reference times from the time data of the corresponding received time telegrams 210, 220 or 220, 250. This target time interval 218, 228 is obtained, in particular, by subtraction of the time data and, if necessary, by subsequent conversion to a time-continuous representation. The latter is especially critical, if the time data in the time telegrams are coded in a manner broken down into year, month, day, hour and second.

The processing path also contains counting devices 340 to count the periods of the continuous carrier signal within the interval stipulated by the frame synchronization unit 324 by the start and end mark signals. In the present exemplary embodiment of the device 300 the start mark signal generated by the frame synchronization unit 324 starts the counter 340, which counts the periods of the continuous carrier signal up to arrival of the end mark signal. The counter 340 is also set up to output the result of this count as a digitally coded numerical value.

The processing path also contains conversion devices 350 to convert the numerical value supplied by counter 340 to a reference time interval. In the exemplary embodiment of device 300 the conversion devices 350 are set up in particular to consider a frequency modulation pattern on the continuous carrier signal during conversion, as described previously. For this purpose the conversion device 350 has the capability of weighting parts of the counter result with different period durations for the entire result.

The processing path also contains comparison devices 360 to compare the target time interval 218, 228 with the reference time interval 270. The comparison devices 360 are set up to produce alternative signals for indication whether the deviation determined by comparison maintains or surpasses the stipulated tolerance value. The signal produced to indicate maintenance by the comparison devices 360 is fed to a control unit 380, which processes the corresponding time telegram based on the incoming signal as verified and conveys it to an actuator 390 that operates in time-dependent fashion. A remotely synchronized verified time base is therefore available to actuator 390. Any error signal produced to indicate surpassing, on the other hand, is fed in the exemplary device to an error control unit 370 and further processed there. Further processing can include production of a signal to be sent to the control unit 380.

The device 300 just explained can advantageously be used to hamper manipulation of time data received via the time telegrams. It therefore works as part of a billing unit for time-based billing, for example, in a charging station, a taximeter, a wind power unit, a solar unit or for units in which time-dependent actions are conducted in which correctness of the available time base must be present.

The device 300 just explained can also be expediently used as part of a time service calculator, time server, trusted platform module (TPM) or hardware security module (HSM).

### LIST OF REFERENCE NUMBERS

100 Signal path
110 First time signal
112 Reference time of a first time signal
120 Second time signal
122 Reference time of a second time signal
130 Third time signal
132 Reference time of a third time signal
170 Reference time interval
180 Reference time interval
200 Data transmission scheme
210 First time telegram
212 Reference time of the first time telegram
214 Start mark signal
216 Time interval
218 Target time interval
220 Second time telegram
222 Reference time of the second time telegram
224 End mark signal
226 Time interval
228 Target time interval
230 Data telegram
240 Third time telegram during disturbed transmission
250 Fourth time telegram
260 Packet time
270 Reference time interval
280 Reference time interval
300 Device for providing a remotely synchronized verified time base
310 Receivers
312 Adapted antenna loop
314 Selective amplifier
316 Filter
320 Decoding devices
322 Frequency demodulator
324 Frame synchronization unit
326 Data decoder
330 Calculation devices
340 Counter
350 Converting devices
360 Comparison devices
370 Error control unit
380 Control unit
390 Actuator

What is claimed is:

1. A method for verification of time data from time signals modulated on a continuous carrier signal, comprising:
receiving a first time signal with a first reference time;
receiving a second time signal with a second reference time which follows the first reference time in time;
calculating a target time interval lying between the first reference time and the second reference time from the time data contained in the received first and second time signals;
determining a time interval and a reference time interval by counting of periods of the continuous carrier signal within the time interval;
comparing the target time interval with the reference time interval; and
outputting an error signal, if the deviation determined by the comparison surpasses a stipulated tolerance value.

2. The method according to claim 1, wherein, for verification of time data from the first and second time signals transmitted in a fixed time grid for determination of the reference time interval, the method further includes counting periods of the period carrier signal in the time interval between the first and second reference times of the received first and second time signals.

3. The method according to claim 1, wherein:
the first time signal and the second time signal comprise time telegrams transmitted in packet-oriented fashion from a loose time grid; and
for determination of the reference time interval, the method includes counting periods of the continuous carrier signal in the time interval between the received time telegrams; and
obtaining the reference time interval by addition of packet times.

4. The method according to claim 3, further comprising determining the packet time by counting of the periods of the continuous carrier signal during transmission of one of the time telegrams.

5. The method according to claim 4, further comprising weighting the counted periods with the period times that vary by frequency modulation during counting of the periods of a frequency-modulated continuous carrier signal.

6. The method according to claim 5, further comprising establishing variation of the period time of the frequency-modulated continuous carrier signal according to data derived from it by demodulation.

7. The method according to claim 5, further comprising establishing the variation of period time of the frequency-modulated continuous carrier signal during determination of the packet time according to a time telegram corresponding to the first reference time.

8. The method according to claim 3, wherein a pre-determined value is added as the packet time.

9. A device for providing a remotely synchronized verified time base, the device comprising:
one or more receivers to receive a continuous carrier signal with modulated time signals;
one or more decoding devices to extract the time signals from the continuous carrier signal and to mark a time interval with start and end mark signals;
one or more calculation devices to calculate a target time interval lying between reference times from time data contained in the received time signals;
one or more counting devices to count periods of the continuous carrier signal in the time interval between the start and end mark signals;
one or more conversion devices to convert the counted periods to a reference time interval; and
one or more comparison devices to compare the target time interval with the reference time interval and to send an error signal to an error control unit, if the deviation determined by the comparison exceeds a stipulated tolerance value.

10. The device according to claim 9, wherein the one or more receivers are designed as direct receivers and especially include a selective amplifier.

11. The device according to claim 9, wherein the one or more decoding devices include:
a demodulator for demodulation of a frequency-modulated signal; and
a frame synchronization unit for frame synchronization of data units transmitted in packet-oriented fashion.

12. The device according to claim 9, wherein the device is designed as a billing unit in a charging station, a taximeter, a wind power unit, solar unit or as another unit in which time-dependent actions are conducted and in which correctness of an available time base must be present.

13. The device according to claim 9, wherein the device is designed as a time service calculator, time server, trusted platform module or hardware security module.
